(19) United States
(12) Patent Application Publication
(10) Pub. No.: US 2011/0036299 A1
(43) Pub. Date: Feb. 17, 2011

(54) FOOD DISPENSER FOR ANIMALS

(76) Inventor: Kristine B. Schehr, Magnolia, TX (US)

Correspondence Address: ARNOLD & KNOBLOCH, L.L.P., 4900 Woodway Dr., Suite 900, HOUSTON, TX, 77056, US

(21) Appl. No.: 12/542,303

(22) Filed: Aug. 17, 2009

(51) Int. Cl. A01K 5/01

(52) U.S. Cl. 119/65

(57) ABSTRACT

A device for feeding animals is provided, the device having an upwardly open enclosure further including a lip disposed about the open portion of the enclosure, a sidewall disposed about the enclosure; and a bottom surface disposed in the interior of the enclosure within the confines of the sidewall. A plurality of upwardly open feeding compartments is disposed in the bottom surface of the enclosure. The feeding compartments further include a shaped sidewall disposed about the compartment and a compartment bottom enclosed within the confines of the shaped sidewall. The compartments are shaped so as to slow the consumption of feed to a safe rate of eating for the animal. The total volume of the compartments equals a single ration of food. The enclosure and sidewall are dimensioned to reduce distractions while the animal is eating and promote freedom of movement of the jaw and neck of the animal during feeding.

### FIELD OF THE INVENTION

The present invention relates generally to portable food dispensers for animals, and in one example, more particularly relates to an apparatus for feeding horses.

### BACKGROUND

Certain animals, horses and dogs in particular, generally suffer from uncontrolled rapid food intake while under human care. Large breed dogs, for example, tend to gulp their food, taking in inappropriate and/or excessive amounts of air while gulping. These dogs can die from gulping food, due to bloat, especially if their owner is away. Horses also suffer from choke when gulping or bolting their feed. Horses suffer from colic, as they have over seventy feet of intestine, but a very small stomach in comparison. By eating too fast, the food can pass to the intestine without being properly first digested by the stomach and with insufficient saliva. (Horses, unlike many other animals, only produce saliva when actually chewing and not in anticipation of food.) This produces gas in the intestine and results in severe pain. The horse tends to roll on the ground to relieve the pain. This rolling, many times, results in twisting the gut and may lead to death.

Other animals may also benefit from application of the present invention, such as livestock, cattle, goats, and cats.

These animals, horses in particular, also tend to be distracted while eating, carrying away and dropping food during the feeding process. It has been discovered that horses alternate between prey or reactive behavior and thinking behavior. During prey behavior, a horse may be distracted while eating, as the horse is constantly aware of its surroundings, including the aggressive action of other horses nearby. This results in a horse grabbing its food, walking or running away from the food supply, and then dropping the food. This food waste may be as high as 50% or more. Further, a horse will attempt to eat the food off the ground, thereby ingesting sand along with the feed. This can lead to sand colic, a serious condition in horses that is expensive and difficult to treat. During thinking behavior, a horse must concentrate and is therefore less distracted by its surroundings. It is therefore advantageous to discover ways to induce the horse into thinking behavior, rather than prey behavior, while feeding.

The present invention slows down the eating process so that the subject animal is less prone to gulp or bolt its food, and chew slowly, producing sufficient saliva. Further, the present invention induces the animal to concentrate more on the task of eating rather than surrounding environmental distractions. The present invention further provides convenient measurement of feed for feeding purposes.

One attempt to address the problem has been to place stones in the bottom of the feeding bucket. Another attempt has been to use a waffle-shaped bottom, which the inventor developed and tested and ultimately found to be unsuccessful. The inventor has found that these attempts did not produce consistent results and introduced other problems, such as the animal chewing the bottom of the bucket and banging the bucket against objects in frustration. This unexpected failure has resulted in extensive experimentation to develop the combination of parameters (and their tolerances and ratios) needed to produce a food dispenser capable of solving the feeding problems described herein.

Accordingly, Applicant has invented a new and non-obvious geometrically shaped feeding device.

### SUMMARY OF THE INVENTION

According to a first set of examples of the invention, an apparatus is disclosed for feeding, the device including: an upwardly open enclosure further including: a lip disposed about the open portion of the enclosure; a sidewall disposed about the enclosure; and a bottom surface disposed in the interior of the enclosure within the confines of the sidewall; a plurality of upwardly open feeding compartments disposed in the bottom surface of the enclosure; and where at least one feeding compartment further includes a shaped sidewall disposed about the compartment and a compartment bottom enclosed within the confines of the shaped sidewall.

In another example, the shaped sidewall of the compartment is sigmoid shaped between the bottom surface opening at the top of the compartment to the compartment bottom.

In another example, the shaped sidewall of the compartment further includes: an upper interior sidewall angled inward and downward from the bottom surface opening at the top of the compartment; a middle interior sidewall angled downward from the upper interior sidewall; and a lower interior sidewall angled inward and downward from the middle interior sidewall to the compartment bottom.

In another example, the upper interior sidewall is angled at thirty-eight degrees from the perpendicular of the bottom surface of the enclosure; the middle interior sidewall is angled at four point eight degrees from the perpendicular of the bottom surface; and the lower interior sidewall is angled at forty-five degrees from the perpendicular of the bottom surface.

In another example, the upper interior sidewall is angled at between thirty-four and forty-one degrees from the perpendicular of the bottom surface of the enclosure; the middle interior sidewall is angled at between four and six degrees from the perpendicular of the bottom surface; and the lower interior sidewall is angled at between forty and fifty degrees from the perpendicular of the bottom surface.

In another example, the width of compartment bottom to the width of middle interior sidewall to the width of the upper opening of upper interior sidewall forms the ratio of 2:3.75:4.

In another example, the distance from the opening in the enclosure to the bottom surface is twelve inches.

In another example, the bottom surface opening at the top of at least one compartment is not greater than five inches.

In another example, the compartment bottom is flat.

In another example, the depth of at least one compartment is not greater than four inches.

In another example, the depth of at least one compartment is not greater than four inches and the bottom surface opening at the top of at least one compartment is not greater than five inches.

In another example, the depth of at least one compartment is three inches.

In another example, the compartment bottom of at least one compartment is forty percent the diameter of the opening of the compartment at the bottom surface of the enclosure.

In another example, the compartment bottom of at least one compartment is between two inches and five inches in width.

In another example, the space between compartments on the bottom surface is between three inches and four inches.

In another example, the bottom surface between the plurality of feeding compartments is flat.

In another example, the diameter of the opening in the enclosure in the proximity of the lip is twenty-four inches and the diameter of the opening in the enclosure at the bottom surface is eighteen inches.

In another example, the cumulative volume of the volumes of the plurality of feeding compartments is set to a desired measured amount of feed.

In another example, the cumulative volume of the volumes of the plurality of feeding compartments is between three and four point two five quarts.

In another example, total height of the feeding device is not greater than fifteen inches.

In another example, the shaped sidewall of the compartment is sigmoid shaped between the bottom surface opening at the top of the compartment to the compartment bottom; the cumulative volume of the volumes of the plurality of feeding compartments is between three and four point two five quarts; the depth of at least one compartment is not greater than four inches; and the bottom surface opening at the top of at least one compartment is not greater than five inches.

### BRIEF DESCRIPTION OF THE DRAWINGS

The present invention is best understood with reference to the attached drawings in which like numerals refer to like elements, and in which:

FIG. 1 illustrates a three-dimensional perspective looking into an example of the present invention;

FIG. 2 illustrates a three-dimensional perspective looking at the outside bottom and side of an example of the present invention; and

FIG. 3 illustrates a cut-away three-dimensional perspective looking at the interior bottom of an example of the present invention.

### DETAILED DESCRIPTION OF THE INVENTION

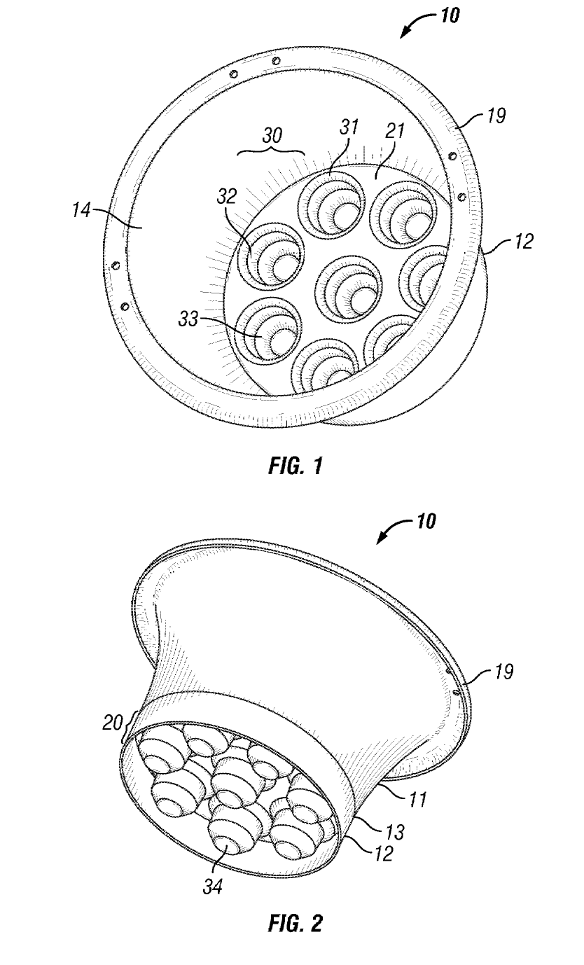

FIG. 1 illustrates a three-dimensional perspective looking into an example of the present invention. In one example, the feeding device is shown as a pail 10 having an interior bottom 21 and interior sidewall 14. Interior bottom 21 has a plurality of compartments 30, forming empty volumes extending downward from the surface of interior bottom 21. In one example, eight compartments 30 are spaced throughout interior bottom 21. The opening of compartment 30 at the surface of interior bottom 21 includes an upper interior sidewall 31 that transitions from the surface of interior bottom 21 to a smaller diameter opening of a middle interior sidewall 32 disposed further into the empty volume of compartment 30. Middle interior sidewall 32 is approximately vertical (perpendicular relative to the average surface of interior bottom 21), extending a distance further into the empty volume of compartment 30. A lower interior sidewall 33 transitions from middle interior sidewall 32 to a smaller-diameter compartment bottom 34. This transition functions as a means for preventing residual food to be stuck in sharp corners. Stuck food will result in horses becoming frustrated, resulting in the horse banging the pail instead of eating. In one example, compartment bottom 34 is generally perpendicular to middle interior sidewall 32 and generally parallel to interior bottom 21. In several examples, the slope of the cavities formed by the compartments is important so that the horses can access all of the feed in each cavity.

In one example, the opening to the interior of pail 10 is trimmed with a lip 19. In one example, lip 19 includes pairs of holes (not numbered) for attachment of a strap or mount.

In one example, an exterior sidewall bottom edge 12 extends at least to the elevation of compartment bottom 34, functioning as a means for providing structural support for pail 10 when pail 10 is placed on a surface in an upright position.

FIG. 2 illustrates a three-dimensional perspective looking at the outside bottom and side of an example of the present invention. Exterior sidewall 11 of pail 10 extends from lip 19 to exterior sidewall bottom edge 12. The diameter of exterior sidewall 11 progressively diminishes from the elevation of lip 19 to an elevation 13, coinciding with the elevation of interior bottom 21 (illustrated in FIG. 1). In one example, the diameter of a portion 20 of exterior sidewall 11 is held generally constant from elevation 13 to the elevation of exterior sidewall bottom edge 12, creating a volume for the occupation of compartments 30. Exterior of compartments 30, including the exterior of compartment bottom 34 are shown disposed on the underside of pail 10.

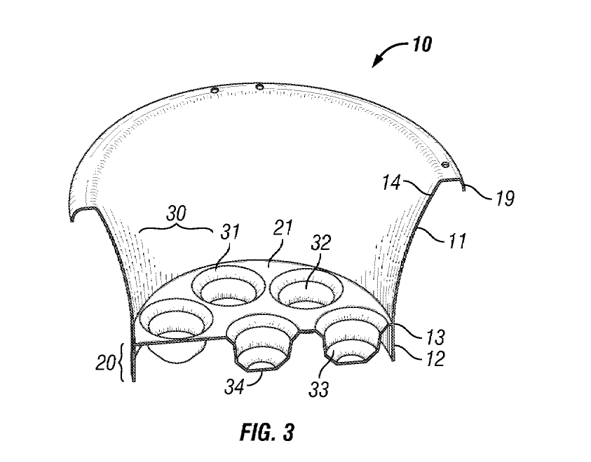

FIG. 3 illustrates a cut-away three-dimensional perspective looking at the interior bottom of an example of the present invention. As previously mentioned, pail 10 includes an exterior sidewall 11. Interior sidewall 14 and exterior sidewall 11 function as a means for containing the animal's head during the consumption of the food. Distractions can cause the animal to lift its head while eating, scattering feed about and causing economic waste.

In one preferred example of the invention, the distance from the top of pail 10 to the top of the feeding compartments 30 (interior bottom 21) is about twelve inches. For horses, this restricts the horse's vision and encourages the horse to use its muzzle (using its nose to smell the feed), and use its tongue and lips to locate and retrieve the feed. This functions to slow down the intake of the feed. Interior sidewall 14 continues to guide the animal's head once its mouth reaches the food and further serves to keep the food in pail 10.

A plurality of feeding compartments 30 is shown. In one example, the multiple feeding compartments 30 serve to meet the dimensional and shape requirements to optimize feeding of the animal. However, the optimal dimension and shape of a single feeding compartment 30 provides insufficient amount of feed. Therefore, multiple compartments, when combined, provide an adequate or correct amount or ration of food for a feeding.

The individual dimensions of each feeding compartment 30 serve to optimize feeding. In one example, the upper interior sidewall 31 of feeding compartment 30 has a diameter no greater than five inches such that the opening to feeding compartment 30 is approximately no greater than five inches. An average horse's area about the muzzle (mouth) is around five inches. A bit is typically about five inches. Therefore, upper interior sidewall 31 being smaller than the horse's muzzle functions as a means to prevent the horse from fitting its whole mouth into feeding compartment 30. This prevents the horse from shoving its entire face and mouth into compartment, preventing the horse from gulping mouthfuls of feed.

In another example, compartment bottom 34 is flat with respect to the general orientation of interior bottom 21 of pail 10. The flat compartment bottom functions as a means for ease in retrieving the feed as it becomes wet from saliva. The feed spreads out rather than becoming hard-to-reach if instead it were collected in a cone-shaped or rounded bottom.

In another example, the depth of feeding compartment 30 is no greater than four inches such that the distance from interior bottom 21 at the opening of upper interior sidewall 31 to compartment bottom 34 is approximately no greater than four inches. For a typical horse, a depth greater than four inches is too difficult for the horse to access the feed with its tongue, given an opening that is constrained to less than five inches. The animal becomes frustrated. Due to the five inch opening, it becomes difficult for a typical horse to access food greater than four inches away.

In another example, the depth of feeding compartment 30 is preferred to be three inches such that the distance from interior bottom 21 at the opening of upper interior sidewall 31 to compartment bottom 34 is approximately three inches. At this depth, it is found to be easier for average sized horses to access with their tongue and lips without frustrating the animal.

In another example, upper interior sidewall 31 and middle interior sidewall 32 and lower interior sidewall 33 collectively form an “S” shaped sidewall to feeding compartment 30. Upper interior sidewall 31 forms an angled sidewall at top of compartment 30, allowing a horse enough access of its muzzle to encourage it to use its tongue and lips to retrieve feed. The angled upper portion of the sidewall therefore functions as a means for preventing chewing of the opening as would be more likely to occur if the opening of compartment 30 included a sharp angle. Middle interior sidewall 32 descends rather vertically from upper interior sidewall 31, forming the inflexion of the “S” shape. Lower interior sidewall 33 forms an angled sidewall at the bottom of compartment 30, connecting middle interior sidewall 32 to compartment bottom 34. The position and arrangement of narrower middle interior sidewall 32 and lower interior sidewall 33 function as a means for preventing the animal from shoving its whole mouth into compartment 30, preventing the gulping of the feed. However, enough access remains at the top portion of compartment 30 for the animal's muzzle. Lower interior sidewall 33 functions as a means for preventing feed from being stuck in corners. The overall “S” shaped configuration functions as a means for promoting use of the tongue by the animal.

In another example, upper interior sidewall 31 of compartment 30 is angled between 34 and 41 degrees (referenced from an imaginary vertical that is perpendicular to the interior bottom). In another preferred example, interior sidewall 31 of compartment 30 is sloped at an angle of 38 degrees. The sloped upper portion of the sidewall of compartment 30 functions as a means for enabling a horse to access the compartment more easily. The slope angle further discourages the animal from trying to grab the top edges of compartment. This reduces the biting tendency of the animal.

In another example, middle interior sidewall 32 of compartment 30 is angled between 4 and 6 degrees (referenced from an imaginary vertical that is perpendicular to the interior bottom). In another preferred example, middle interior sidewall 32 is angled at 4.8 degrees. The middle portion of the sidewall functions as a means for coning the feed downward during eating. This reduces sticking of feed to the sidewall caused by saliva.

In another example, lower interior sidewall 33 of compartment 30 is angled between 40 and 50 degrees (referenced from an imaginary vertical that is perpendicular to the interior bottom). In another preferred example, lower interior sidewall 33 is angled at 45 degrees. The lower portion of the sidewall functions as a means for preventing feed from being stuck in corners.

In another example, the diameter of compartment bottom 34 of compartment 30 is about forty percent of the diameter of the upper opening of compartment 30. In another preferred example, the diameter of compartment bottom 34 is between two and five inches. This ratio was found to result from accommodation of the other concerns and functional considerations that render the apparatus operable for successful feeding.

In another example, the width of compartment bottom 34 to the width of middle interior sidewall 32 to the width of the upper opening of upper interior sidewall 31 forms the ratio of 2:3.75:4. In another example, the width of compartment bottom 34 to the width of middle interior sidewall 32 to the width of the upper opening of upper interior sidewall 31 forms an x:y:z ratio of: (1.75<x<=2):(3.0<y<=3.75):(4<=z<6). In another example, the width of compartment bottom 34 to the width of middle interior sidewall 32 to the width of the upper opening of upper interior sidewall 31 forms an x:y:z ratio of: (2<=x<3):(3.75<=y<4):(3<z<=4). In another example, the width of compartment bottom 34 to the width of middle interior sidewall 32 to the width of the upper opening of upper interior sidewall 31 forms an x:y:z ratio of: (1.75<x<3):(3.75<y<4):(3<z<6).

The positioning and arrangement of compartments 30 about interior bottom 21 of pail 10 also serve to optimize feeding. In one example, compartments 30 are positioned about interior bottom 21 such that a space of three to four inches exists between each compartment. If the space between compartments 30 is smaller than three to four inches then the horse is able to grasp with its teeth and chew on the interior bottom of pail 10. If the space between compartments 30 is greater than three to four inches then the overall diameter of pail 10 becomes excessive and less convenient for use. The blinder effect is also reduced.

In another example, interior bottom 21 of pail 10 presents as a flat surface between compartments 30. The flat surface arrangement functions as a means for holding the compartments in properly measured spaces. Sloped or angled inter-compartment spaces tend to encourage a horse to try to grab the interior bottom of the pail with its teeth. Additionally, it is found that the horse runs its muzzle across the surface and upon sensing the surface to be smooth and flat will commence eating from the compartments. Conversely the horse can become frustrated, angry, and/or aggressive in tests where a non-smooth surface was tested. The horse will take the feeding pail in its mouth and bang the feeding pail.

The shape and dimensions of pail 10 also serve to optimize feeding. In one example, the upper opening of interior sidewall 14 of pail 10 is 24 inches in diameter and the diameter of pail 10 at elevation 13, at the level of interior bottom 21, is 18 inches in diameter. In a further example, the interior sidewall 14 of pail 10 is progressively curved from the upper opening diameter to the diameter at the elevation of the interior bottom. The sidewall of the pail is therefore sloped, which functions as a means for allowing the horse's head and jaw better access to the feed.

In another example, the sum of the volumes of all compartments 30 total between 3 and 4 quarts. In another example, the upper limit of total volume is adjusted slightly upward to hold slightly more than the sum of a feeding (meal) as recommended by veterinarian or a Feed Specialist. The upward adjustment allows for addition of supplements to the feed. In another example, the sum of the volumes of all compartments 30 total between 3 and 4.25 quarts. In another preferred example, the sum of the volumes of all compartments 30 total slightly more than four quarts. The sum of the volumes of all compartments function as a means for fitting all feed for a single ration of feed into the compartments without overflow outside of the compartments and into the rest of pail 10. Previous attempts failed because food sat on top of waffles, causing the horse to push food to the side and then scoop up the food rather than lick the food.

In another example, the total height of pail 10 from lip 19 to the exterior sidewall bottom edge 12 (including all of portion 20 of exterior sidewall 11) is fifteen (15) inches, such that the total height of pail 10 is approximately fifteen (15) inches. The height of pail 10 functions as a means for slowing the horse's feed consumption down to an ideal rate. This further puts horses in a relaxed state. The pail height when combined with the positioning and arrangement of the feeding compartments further functions as a means for: reducing the risk of choke, as the horse takes in less feed with each bite; keeping the animal's head down in the feeder for a longer period of time; reducing feed waste by reducing the number of head lifts out of feeder to look around; and reducing the amount of feeding from the ground, reducing consumption by the animal of sand, dirt and parasites. The pail height, when combined in conjunction with the other dimensional requirements functions as a means for enabling freedom of movement of the jaw and neck of the animal while the animal is working through eating the food in all the compartments. This is important because the horse's neck extends downward (as nature intended it for grazing) and this aids in desired saliva flow. Horses are natural grazers and eat with their head lowered. The proper saliva flow helps prevent grain from getting stuck in the throat. By causing the horse to eat for an extended period of time, the animal gets adequate salvia flow.

In another example, holes are placed in lip 19 of pail 10 to allow attachment to stall walls. In a further example, three sets of holes are placed in lip 19 to allow pail 10 to be hung such that pail 10 can swing about while the horse is eating.

Thus, the apparatus addresses a long-felt but un-resolved need that has been sought for a way to slow ingestion to prevent choke. Further, a surprising result has been that the horse changes it mode of thinking such that it no longer raises its head (causing waste) in a reactive mode. The animal stops using its eyes to look for food between bites, feeding with its mouth, using the tongue and lips to retrieve its food. Another surprising result is that the animal tends not to kick around the bucket, even though the bucket is light weight.

The foregoing disclosure is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant in the art having the benefit of the present disclosure. Further, the embodiments described are also intended to explain the best mode for carrying out the invention, and to enable others skilled in the art to utilize the invention and such or other embodiments and with various modifications required by the particular applications or uses of the invention. It is intended that the claims based on this disclosure be construed to include alternative embodiments to the extent that is permitted by prior art.

I claim:

1. A feeding device comprising:
an upwardly open enclosure further comprising:
a lip disposed about the open portion of the enclosure;
a sidewall disposed about the enclosure; and
a bottom surface disposed in the interior of the enclosure within the confines of the sidewall;
a plurality of upwardly open feeding compartments disposed in the bottom surface of the enclosure; and
wherein at least one feeding compartment further comprises a shaped sidewall disposed about the compartment and a compartment bottom enclosed within the confines of the shaped sidewall.

2. The feeding device of claim 1 wherein the shaped sidewall of the compartment is sigmoid shaped between the bottom surface opening at the top of the compartment to the compartment bottom.

3. The feeding device of claim 1 wherein the shaped sidewall of the compartment further comprises:
an upper interior sidewall angled inward and downward from the bottom surface opening at the top of the compartment;
a middle interior sidewall angled downward from the upper interior sidewall; and
a lower interior sidewall angled inward and downward from the middle interior sidewall to the compartment bottom.

4. The feeding device of claim 3 wherein: the upper interior sidewall is angled at thirty-eight degrees from the perpendicular of the bottom surface of the enclosure; the middle interior sidewall is angled at four point eight degrees from the perpendicular of the bottom surface; and the lower interior sidewall is angled at forty-five degrees from the perpendicular of the bottom surface.

5. The feeding device of claim 3 wherein: the upper interior sidewall is angled at between thirty-four and forty-one degrees from the perpendicular of the bottom surface of the enclosure; the middle interior sidewall is angled at between four and six degrees from the perpendicular of the bottom surface; and the lower interior sidewall is angled at between forty and fifty degrees from the perpendicular of the bottom surface.

6. The feeding device of claim 3 wherein the width of compartment bottom to the width of middle interior sidewall to the width of the upper opening of upper interior sidewall forms the ratio of 2:3.75:4.

7. The feeding device of claim 1 wherein the distance from the opening in the enclosure to the bottom surface is twelve inches.

8. The feeding device of claim 1 wherein the bottom surface opening at the top of at least one compartment is not greater than five inches.

9. The feeding device of claim 1 wherein the compartment bottom is flat.

10. The feeding device of claim 1 wherein the depth of at least one compartment is not greater than four inches.

11. The feeding device of claim 1 wherein the depth of at least one compartment is not greater than four inches and the bottom surface opening at the top of at least one compartment is not greater than five inches.

12. The feeding device of claim 1 wherein the depth of at least one compartment is three inches.

13. The feeding device of claim 1 wherein the compartment bottom of at least one compartment is forty percent the diameter of the opening of the compartment at the bottom surface of the enclosure.

14. The feeding device of claim 1 wherein the compartment bottom of at least one compartment is between two inches and five inches in width.

15. The feeding device of claim 1 wherein the space between compartments on the bottom surface is between three inches and four inches.

16. The feeding device of claim 1 wherein the bottom surface between the plurality of feeding compartments is flat.

17. The feeding device of claim 1 wherein the diameter of the opening in the enclosure in the proximity of the lip is twenty-four inches and the diameter of the opening in the enclosure at the bottom surface is eighteen inches.

18. The feeding device of claim 1 wherein the cumulative volume of the volumes of the plurality of feeding compartments is set to a desired measured amount of feed.

19. The feeding device of claim 1 wherein the cumulative volume of the volumes of the plurality of feeding compartments is between three and four point two five quarts.

20. The feeding device of claim 1 wherein the total height of the feeding device is not greater than fifteen inches.

21. The feeding device of claim 1:
wherein the shaped sidewall of the compartment is sigmoid shaped between the bottom surface opening at the top of the compartment to the compartment bottom;
wherein the cumulative volume of the volumes of the plurality of feeding compartments is between three and four point two five quarts;
wherein the depth of at least one compartment is not greater than four inches; and
wherein the bottom surface opening at the top of at least one compartment is not greater than five inches.
